(19) United States
(12) Patent Application Publication
(10) Pub. No.: US 2026/0282177 A1
(43) Pub. Date: Sep. 17, 2026

(54) COOKING APPLIANCE

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: HaoSheng YANG, Foshan City (CN); Qian LIU, Foshan City (CN); ZhouPing WANG, Foshan City (CN); ChaoHua CUI, Foshan City (CN); WeiChang FENG, Foshan City (CN)

(21) Appl. No.: 19/569,149

(22) Filed: Mar. 17, 2026

(30) Foreign Application Priority Data
Mar. 17, 2025 (CN) 202520458441.X
Mar. 28, 2025 (CN) 202520570123.2
Apr. 11, 2025 (CN) 202520679847.0
Apr. 11, 2025 (CN) 202520680010.8
Apr. 15, 2025 (CN) 202510467528.8

(51) Int. Cl. H05B 6/64

(52) U.S. Cl. CPC H05B 6/642; H05B 6/6444; H05B 6/645

(57) ABSTRACT

The present invention provides a cooking appliance, comprising a heat insulation cavity assembly, the heat insulation cavity assembly comprising a cooking cavity and a heat insulation frame, a heat insulation member being disposed between the cooking cavity and the heat insulation frame, and a heat dissipation structure being disposed outside the heat insulation cavity assembly. The present invention can effectively prevent heat in the oven cavity from being transferred to the outside, preventing excessive heat dissipation load in the electrical cavity; meanwhile, the heat dissipation structure can ensure operational reliability of key components, which is critical for cooking appliances having dual magnetrons.

### CROSS-REFERENCE TO RELATED APPLICATIONS

This application claims priority to Chinese Patent Application No. 202520458441.X filed with the China National Intellectual Property Administration (CNIPA) on Mar. 17, 2025, and Chinese Patent Application No. 202520570123.2 filed with CNIPA on Mar. 28, 2025, and Chinese Patent Application No. 202520679847.0 filed with CNIPA on Apr. 11, 2025, and Chinese Patent Application No. 202520680010.8 filed with CNIPA on Apr. 11, 2025, and Chinese Patent Application No. 202510467528.8 filed with CNIPA on Apr. 15, 2025, the disclosures of all of which are incorporated herein by reference in their entireties.

### TECHNICAL FIELD

The present invention relates to the field of household appliances technology, and more particularly, to a cooking appliance.

### BACKGROUND

With the ever-increasing performance demands of modern households for kitchen appliances, cooking appliances represented by cooking appliances and steam ovens, as commonly used kitchen appliances, have seen their heating efficiency and heating uniformity become focal points of user concern. Traditional cooking appliances generally employ a single magnetron, directing microwaves into the oven cavity through a single waveguide to heat food. However, due to the limited power and microwave radiation range of a single magnetron, this limitation often results in uneven microwave distribution within the oven cavity, particularly when heating larger or irregularly shaped foods, where significant heating differences occur among various parts of the food, which affects heating performance. To this end, dual-magnetron cooking appliances have emerged and have gradually become representative of high-end cooking appliance products.

However, the oven cavity walls of existing cooking appliances possess certain thermal conductivity, causing a portion of the heat within the oven cavity to be conducted to the exterior of the oven cavity, which can easily cause excessive temperatures within the electrical cavity or even high-temperature damage to electrical components, and this is especially true for cooking appliances equipped with dual magnetrons. Traditional heat dissipation structures cannot meet the heat dissipation requirements of dual-magnetron cooking appliances.

### SUMMARY

To solve the above problems, the present invention provides a cooking appliance which comprises a heat insulation cavity assembly, the heat insulation cavity assembly comprising a cooking cavity and a heat insulation frame arranged sequentially from inside to outside, a heat insulation member being disposed between the cooking cavity and the heat insulation frame, the heat insulation member being connected with the heat insulation frame and the cooking cavity; a heat dissipation structure being disposed outside the heat insulation cavity assembly.

Preferably, the cooking appliance comprises a base, the base being located below the heat insulation cavity assembly, an air inlet structure being disposed on a front side of the base, a first magnetron, a second magnetron, and an electronic control structure being disposed between the heat insulation cavity assembly and the base; a first heat dissipation structure being disposed on a side portion of the first magnetron, a second heat dissipation structure being disposed on a side portion of the second magnetron, the electronic control structure being disposed between an inlet end of the first heat dissipation structure and/or the second heat dissipation structure and the air inlet structure.

Preferably, the first heat dissipation structure and the second heat dissipation structure are provided with a sponge member on a side close to the base, the sponge member cooperating with the first heat dissipation structure and the second heat dissipation structure to form an air inlet space, and the electronic control structure being located within the air inlet space.

Preferably, the first heat dissipation structure comprises a first fan and a first air guide member, the first fan being disposed on an air inlet side of the first magnetron, the first air guide member being disposed on an air outlet side of the first magnetron, an end of the first air guide member remote from the first magnetron being provided with a first air outlet.

Preferably, the first heat dissipation structure comprises a second lower air duct, a first inverter being disposed in the second lower air duct, the first inverter being electrically connected to the first magnetron, a second fan being disposed on an air inlet side of the second lower air duct, a second exhaust outlet being disposed on an air outlet side of the second lower air duct, the second exhaust outlet being in communicating with a heat dissipation air outlet hole.

Preferably, the second lower air duct comprises a second lower housing, the second lower housing being provided with a second wire groove, a second partition plate being disposed between the second lower housing and the first air guide member, the second partition plate comprising a connecting plate and a second folded edge that are connected, the second folded edge extending toward one side of the second lower housing and at least partially covering the second wire groove.

Preferably, the second heat dissipation structure comprises a third fan and a second air guide member, an air outlet side of the third fan is in communication with an air inlet side of the second magnetron, a second air guide member is disposed on an air outlet side of the second magnetron, and a second air outlet is disposed at an end of the second air guide member remote from the second magnetron.

Preferably, the second heat dissipation structure further comprises a mounting bracket and a blocking member, the mounting bracket is configured to fix the second fan, the blocking member is located at a side of the mounting bracket proximate to the second magnetron, the blocking member comprises a third partition plate disposed vertically, and a gap exists between the third partition plate and the mounting bracket.

Preferably, the second heat dissipation structure further comprises a first lower air duct and a fourth fan, a second inverter is disposed inside the first lower air duct, the second inverter is electrically connected to the second magnetron, the fourth fan is disposed at an inlet side of the first lower air duct, and a first exhaust outlet is disposed at an air outlet side of the first lower air duct.

Preferably, a rear air duct is disposed behind the heat insulation cavity assembly, the rear air duct has a first flow channel and a second flow channel, the first flow channel is in communication with a first exhaust outlet, the second flow channel is in communication with a second air outlet, and an air outlet direction of the first flow channel and an air outlet direction of the second flow channel are both parallel to a wall directly facing a rear side of the cooking appliance.

Preferably, the cooking appliance comprises a rear housing, the rear housing has a rear protrusion, a side wall of the rear protrusion is provided with a first air outlet hole and a second air outlet hole, the first air outlet hole is disposed corresponding to an air outlet of the first flow channel, and the second air outlet hole is disposed corresponding to an air outlet of the second flow channel.

Preferably, the cooking appliance further comprises a lighting assembly and a temperature sensing assembly located at a side of the heat insulation cavity assembly, an air guide cover is provided at the side of the heat insulation cavity assembly, and a fifth fan is provided at one end of the air guide cover, configured to drive air flow to simultaneously dissipate heat from the lighting assembly and the temperature sensing assembly.

Preferably, the air guide cover comprises a first bottom plate arranged in close contact with the heat insulation cavity assembly, a first baffle plate is provided at a periphery of the first bottom plate, and the first bottom plate and the first baffle plate enclose to form a mounting position for fixedly assembling the fifth fan; an air supply opening is provided on one side of the first baffle plate for delivering air to the lighting assembly and the temperature sensing assembly.

Preferably, the air guide cover is provided with an air induction member on a side away from the first bottom plate, a microswitch is provided at a side of the heat insulation cavity assembly, and the air induction member is disposed directly facing the microswitch for dissipating heat from the microswitch.

Preferably, the cooking appliance further comprises a mounting plate, the mounting plate is fixed on the heat insulation frame, the air guide cover is provided on a side of the mounting plate away from the heat insulation frame, an air supply air duct is formed between the air guide cover and the mounting plate, and the mounting plate is made of non-metallic material.

Preferably, the cooking appliance comprises a door assembly, the door assembly comprising:
a door cover plate;
a heat dissipation air duct formed in the door cover plate, wherein an electronic control box and a fan assembly are provided within the heat dissipation air duct.

Preferably, the heat dissipation air duct comprises a first inlet and a first outlet, and both the first inlet and the first outlet are located at a bottom of the door cover plate.

Preferably, the fan assembly is disposed below the electronic control box, and a first air guide structure is disposed at an outlet of the fan assembly, and the first air guide structure is capable of guiding cold air blown out by the fan assembly into the interior of the electronic control box.

Preferably, the first air guide structure comprises a mounting plate and an air guide plate, the air guide plate is vertically disposed above the mounting plate, and the air guide plate is configured as an arcuate structure.

Preferably, an airflow channel is formed inside the electronic control box, a second air guide structure is disposed on one side above the electronic control box, an air outlet channel is formed between the second air guide structure and the door cover plate, and the second air guide structure is capable of directing air exiting from the interior of the electronic control box to flow along the air outlet channel to a side away from the electronic control box.

Compared with the prior art, the cooking appliance according to embodiments of the present invention has the following beneficial effects: 1) it effectively prevents heat in the oven cavity from being transferred to the outside and to the electrical cavity, thereby avoiding excessive heat dissipation load or even overheating in the electrical cavity, which could damage to electrical components; 2) the first and second heat dissipation structure enable heat dissipation for the two microwave generating devices, balancing heating efficiency and heat dissipation performance of the cooking appliance; while utilizing the first heat dissipation structure or the second heat dissipation structure to dissipate heat from the microwave generating devices, external air is driven to enter and first flow through the electronic control structure, thereby ensuring stable and reliable operation of the electronic control structure with a long service life; 3) the rear air duct enables bottom heat dissipation airflow to respectively enter corresponding flow channels in the rear air duct, and then flow out of the rear air duct in a direction parallel to the wall, flowing directly outward along the wall in a relatively smooth manner; 4) by integrating the fan assembly and the heat dissipation air duct inside the door assembly, efficient heat dissipation of the electronic control box is ensured while assisting overall heat dissipation of the door assembly.

### BRIEF DESCRIPTION OF THE DRAWINGS

FIG. 1 is an axonometric view of the cooking appliance according to an embodiment of the present invention from a rear perspective;

FIG. 2 is a schematic structural view of the cooking appliance (with the rear housing and base removed) according to an embodiment of the present invention;

FIG. 3 is a schematic structural view of the cooking appliance in an “upside-down” state (rear perspective) according to an embodiment of the present invention;

FIG. 4 is a schematic structural view of the cooking appliance in an “upside-down” state according to an embodiment of the present invention;

FIG. 5 is an exploded view of the second lower air duct of the cooking appliance in an “upside-down” state according to an embodiment of the present invention;

FIG. 6 is an exploded view of the first lower air duct and the rear air duct of the cooking appliance in an “upside-down” state according to an embodiment of the present invention;

FIG. 7 is an exploded view of the first lower air duct, the third fan, and the fourth fan according to an embodiment of the present invention (in an “upside-down” state);

FIG. 8 is a schematic structural view of the second partition plate according to an embodiment of the present invention;

FIG. 9 is a schematic structural view of the first lower housing in an approximately top view perspective according to an embodiment of the present invention;

FIG. 10 is a schematic structural view of the rear air duct in a front-to-rear perspective according to an embodiment of the present invention;

FIG. 11 is a schematic structural view of one side portion of the cooking appliance according to an embodiment of the present invention;

FIG. 12 is an exploded view of one side portion of the cooking appliance according to an embodiment of the present invention;

FIG. 13 is a schematic structural view of the air guide cover according to an embodiment of the present invention;

FIG. 14 is another perspective view of the air guide cover according to an embodiment of the present invention;

FIG. 15 is a schematic structural view of the cooking appliance according to an embodiment of the present invention;

FIG. 16 is a structural schematic diagram of the door assembly according to an embodiment of the present invention;

FIG. 17 is another perspective view of the door assembly according to an embodiment of the present invention;

FIG. 18 is a structural schematic diagram of the cooking appliance (with the door assembly removed) according to an embodiment of the present invention;

FIG. 19 is an overall schematic diagram of the cooking appliance according to an embodiment of the present invention;

FIG. 20 is another perspective view of the cooking appliance according to an embodiment of the present invention;

FIG. 21 is a partially enlarged schematic diagram of area A in FIG. 20;

FIG. 22 is a longitudinal cross-sectional schematic diagram along the A-A side of FIG. 19;

FIG. 23 is a longitudinal cross-sectional schematic diagram along the B-B side of FIG. 19;

FIG. 24 is a structural schematic diagram of the connecting rod according to an embodiment of the present invention.

### DESCRIPTION OF REFERENCE NUMERALS

1—rear air duct; 11—clearance protrusion; 111—clearance portion; 12—upper air outlet; 13—side air outlet; 14—first flow channel; 141—first air inlet end; 15—second flow channel; 2—first lower air duct; 20—first air chamber; 21—first lower housing; 211—first wire groove; 22—first upper housing; 23—first exhaust outlet; 24—second air chamber; 241—air inlet end; 242—air outlet end; 25—fan mounting position; 26—first partition plate; 3—second lower air duct; 31—second lower housing; 311—second wire groove; 32—second upper housing; 33—second exhaust outlet; 4—first magnetron; 41—first fan; 42—first air guide member; 43—first air outlet; 44—second partition plate; 441—second folded edge; 442—connecting plate; 5—first inverter; 51—second fan; 52—mounting bracket; 521—third wire groove; 53—blocking member; 6—second magnetron; 61—third fan; 62—second air guide member; 63—second air outlet; 7—second inverter; 71—fourth fan; 72—heat sink; 8—air guide cover; 81—first bottom plate; 82—first baffle plate; 83—second bottom plate; 831—first air duct; 832—second air duct; 833—third air duct; 84—air supply opening; 85—second baffle plate; 851—blocking plate; 86—snap-fit member; 87—air induction member; 9—heat insulation cavity assembly; 90—partition member; 91—cooking cavity; 9101—first space; 9102—second space; 10—first mounting plate; 121—lighting assembly; 1211—first lamp body; 1212—second lamp body; 122—temperature sensing assembly; 123—microswitch; 125—fifth fan; 101—door assembly; 1011—door cover plate; 10111—electronic control mounting area; 1012—electronic control box; 1013—heat dissipation air duct; 10131—first inlet; 10132—first outlet; 1014—fan assembly; 1015—first air guide structure; 10151—second mounting plate; 10152—air guide plate; 1016—second air guide structure; 10161—first air outlet baffle plate; 10162—second air outlet baffle plate; 102—housing; 103—base; 1031—heat dissipation air outlet hole; 104—rear housing; 1041—rear protrusion; 1042—first air outlet hole; 1043—second air outlet hole; 1044—side wall; 105—first motor; 106—electronic control structure; 100—sponge member; 130—first temperature sensing member; 140—second temperature sensing member; 150—heating assembly; 151—first heating element; 152—second heating element; 300—microwave stirring device; 310—second motor; 320—connecting rod; 3210—first connecting portion; 3220—second connecting portion; 3230—extension plate; 3240—first plug-in hole; 330—stirrer; 340—first bracket; 350—sensing member; 360—second bracket; 3610—second protrusion; 370—coupler; 380—connecting shaft sleeve; 400—first waveguide housing; 410—third protrusion; 4110—annular rib; 500—second waveguide housing.

### DETAILED DESCRIPTION OF THE EMBODIMENTS

In order to make the above objectives, features, and advantages of the present invention more apparent and understandable, detailed descriptions of specific embodiments of the present invention are provided below in conjunction with the drawings. The embodiments of the present invention and features in the embodiments may be combined with each other without conflict.

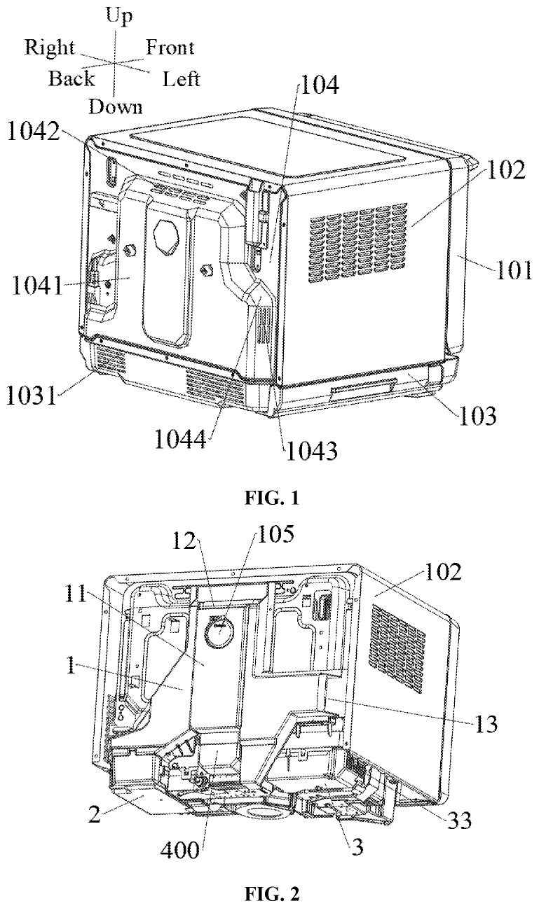

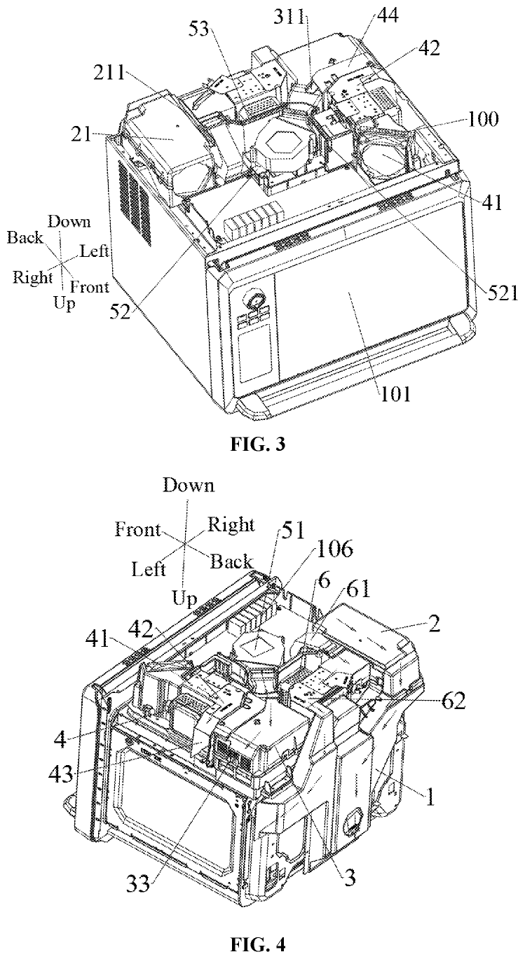

Since some of the drawings in this application show the cooking appliance in an “upside-down” orientation, to avoid misunderstanding, the directional terms in this application are all based on the orientation of the cooking appliance in its normal assembly and normal placement state, with reference to the coordinate systems in FIG. 1 and FIG. 3.

### Embodiment 1

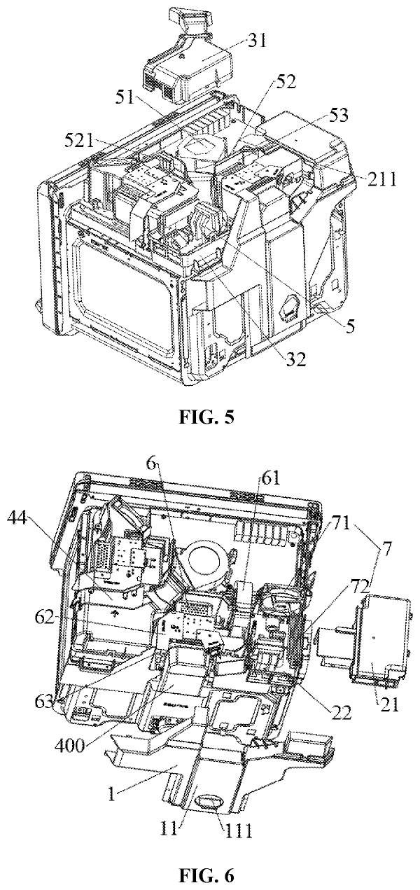

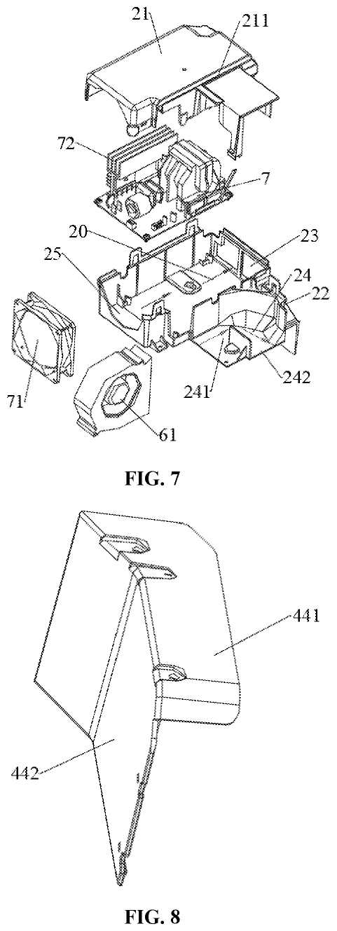

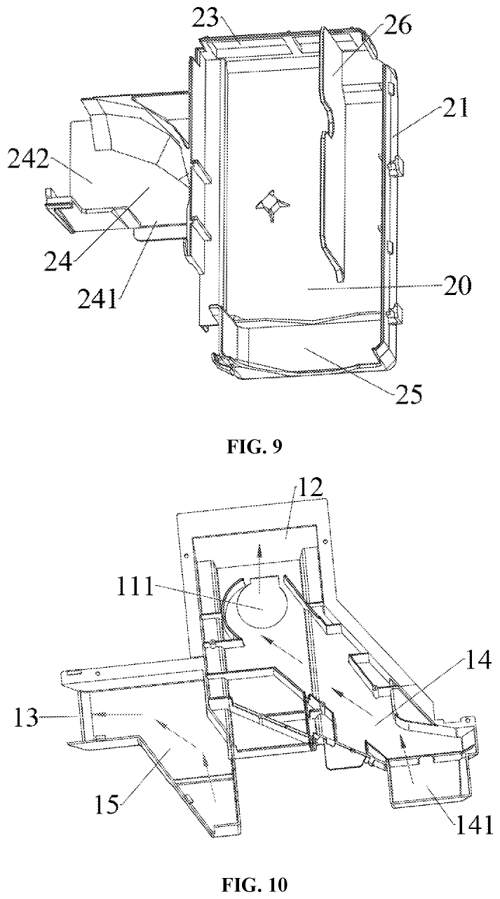

As shown in FIGS. 1-10, a cooking appliance comprises a base 103, a heat insulation cavity assembly 9 disposed above the base 103, an air inlet structure disposed at a front side of the base 103, and a first magnetron 4, a second magnetron 6, and an electronic control structure 106 disposed below the heat insulation cavity assembly 9. The first magnetron 4 and the second magnetron 6 respectively deliver microwaves inward from the bottom and rear of the heat insulation cavity assembly 9. A first heat dissipation structure is disposed at a side of the first magnetron 4, and a second heat dissipation structure is disposed at a side of the second magnetron 6. The electronic control structure 106 is disposed between an inlet end of the first heat dissipation structure and/or the second heat dissipation structure and the air inlet structure.

The cooking appliance of this application can dissipate heat from the two microwave generating devices by providing the first heat dissipation structure and the second heat dissipation structure, thereby achieving a balance between heating efficiency and heat dissipation performance of the cooking appliance. Meanwhile, by disposing the electronic control structure 106 between the air inlet structure and the inlet end of the first heat dissipation structure or the second heat dissipation structure, while the first heat dissipation structure or the second heat dissipation structure dissipates heat from the microwave generating devices, external air is driven to enter and first flow through the electronic control structure 106, thereby ensuring stable and reliable operation of the electronic control structure 106 and extending its service life.

Preferably, the first heat dissipation structure and the second heat dissipation structure are provided with a sponge member 100 on a side close to the base 103, the sponge member 100 cooperates with the first heat dissipation structure and the second heat dissipation structure to form an air inlet space, and the electronic control structure 106 is located within the air inlet space.

This arrangement can achieve flexible contact between the first heat dissipation structure and the second heat dissipation structure and the base 103, providing vibration reduction and isolation effects; meanwhile, by providing the sponge member 100, a sealing effect can be achieved, allowing air to flow through a preset air duct, resulting in good heat dissipation effects for components.

Preferably, the sponge member 100 is thermal insulation cotton and is composed of multiple line segments. This arrangement allows the sponge member 100 to extend utilizing the existing structures of the first heat dissipation structure and the second heat dissipation structure, resulting in high space utilization. The sponge member 100 may also be other elastic materials.

As an example of the present invention, at least one of the rear side wall, left side wall, right side wall, and bottom wall of the base 103 is provided with a heat dissipation air outlet hole 1031; The first heat dissipation structure includes a first fan 41 and a first air guide member 42, the first fan 41 is disposed on the air inlet side of the first magnetron 4, the first air guide member 42 is disposed on the air outlet side of the first magnetron 4, an end of the first air guide member 42 remote from the first magnetron 4 is provided with a first air outlet 43, and the first air outlet 43 is capable of communicating with the heat dissipation air outlet hole 1031.

Preferably, the first heat dissipation structure includes a second lower air duct 3, a first inverter 5 is disposed in the second lower air duct 3, the first inverter 5 is electrically connected to the first magnetron 4, a second fan 51 is disposed on the air inlet side of the second lower air duct 3, a second exhaust outlet 33 is disposed on the air outlet side of the second lower air duct 3, and the second exhaust outlet 33 is capable of communicating with the heat dissipation air outlet hole 1031.

As an example of the present invention, the second lower air duct 3 is assembled from a second lower housing 31 and a second upper housing 32, which will not be elaborated upon here.

Preferably, the second lower housing 31 is provided with a second wire groove 311, a second partition plate 44 is disposed between the second lower housing 31 and the first air guide member 42, the second partition plate 44 comprises a connecting plate 442 and a second folded edge 441 that are connected to each other, and the second folded edge 441 extends toward one side of the second lower housing 31 and at least partially covers the second wire groove 311.

This arrangement can shield the second wire groove 311 and prevent the connecting wires from escaping from the second wire groove 311 under the action of gravity, thereby providing a good wire fixing effect; furthermore, the second partition plate 44 and the first air guide member 42 form a double-layer structure, and even further cooperate with the second lower housing 31 to form a triple-layer structure, thereby preventing the heat generated by the first magnetron 4 from diffusing outward and affecting the operation of the first inverter 5, ensuring stable and reliable operation of the first inverter 5.

As an example of the present invention, the second partition plate 44 is fixedly connected to the first air guide member 42 and the second lower housing 31, respectively. This arrangement enables the first heat dissipation structure to form an integral unit, preventing loosening after long-term use and even potential safety hazards.

As an example of the present invention, the second fan 51 is fixed below the bottom of the heat insulation cavity assembly 9 through a mounting bracket 52, the mounting bracket 52 is provided with a third wire groove 521 on the side close to the first magnetron 4, and the third wire groove 521 cooperates with the second wire groove 311 to form a wiring structure. This arrangement can constrain the connecting wires and reinforce the structure of the mounting bracket 52.

The second heat dissipation structure comprises a third fan 61 and a second air guide member 62, an air outlet side of the third fan 61 is in communication with an air inlet side of the second magnetron 6, the second air guide member 62 is disposed on an air outlet side of the second magnetron 6, and a second air outlet 63 is disposed at an end of the second air guide member 62 remote from the second magnetron 6.

Preferably, the second heat dissipation structure further comprises a blocking member 53, the blocking member 53 is located on a side of the mounting bracket 52 close to the second magnetron 6, the blocking member 53 comprises a third partition plate disposed vertically, and a gap exists between the third partition plate and the mounting bracket 52.

This arrangement enables a double-layer structure to be formed on the side of the second magnetron 6 close to the air inlet space, thereby preventing the heat generated by the second magnetron 6 from directly diffusing into the air inlet space, ensuring that the air inlet temperature of the third fan 61 is not excessively high, and providing a good heat dissipation effect for the second inverter 7.

Preferably, one side of the blocking member 53 is fixedly connected to the third fan 61. This arrangement enables the second heat dissipation structure to form an integrated unit, preventing loosening of individual components and generation of noise, thereby providing good operational stability of the cooking appliance.

Preferably, the second heat dissipation structure further comprises a first lower air duct 2 and a fourth fan 71, wherein a second inverter 7 is disposed inside the first lower air duct 2, the second inverter 7 is electrically connected to the second magnetron 6, the fourth fan 71 is disposed at an inlet side of the first lower air duct 2, and a first exhaust outlet 23 is disposed at an air outlet side of the first lower air duct 2.

Wherein the fourth fan 71 may be fixed to the exterior of the first lower air duct 2 or may be fixed to the interior thereof, and the present application does not impose excessive limitations thereon. Preferably, a fan mounting position 25 is disposed within the first lower air duct 2, and the fourth fan 71 can be installed at the fan mounting position 25.

Taking into comprehensive consideration various requirements such as the size of the fan air intake space and space limitations for component arrangement, a fan corresponding to the third fan 61 of the present application is disposed in the narrow gap between the magnetron and the air duct structure, such that even when the fan operates under overload conditions, there is insufficient air intake space, making it difficult to draw in sufficient air and impossible to ensure the flow rate of the heat dissipation airflow.

Preferably, the first lower air duct 2 comprises a first air chamber 20, the second inverter 7 is disposed in the first air chamber 20, the fourth fan 71 is disposed on a side of the first air chamber 20 remote from the rear air duct 1, and the first exhaust outlet 23 is disposed on a side of the first air chamber 20 proximate to the rear air duct 1.

The first lower air duct 2 is provided with a second air chamber 24 on a side of the first air chamber 20 proximate to the second magnetron 6, wherein the first air chamber 20 and the second air chamber 24 constitute mutually independent air duct structures. In the field of mechanical design, this is directly achieved by disposing a partition plate between the first air chamber 20 and the second air chamber 24, thereby making the two spatially independent from each other, and no further elaboration is provided herein.

An air inlet end 241 of the second air chamber 24 is in communication with or connected to an air outlet side of the third fan 61, and an air outlet end 242 of the second air chamber 24 is in communication with or connected to an air inlet side of the second magnetron 6. Thus, without affecting heat dissipation of the second inverter 7, by additionally disposing the second air chamber 24 in the narrow gap between the magnetron and the air duct structure, the third fan 61 can be moved out of this narrow gap, enabling the third fan 61 to have a larger air intake space, which facilitates increasing the flow rate of the heat dissipation airflow and further improves the heat dissipation effect. Preferably, the second air chamber 24 has a smoothly transitioning space, enabling airflow to flow smoothly through the second air chamber 24.

Correspondingly, for each fan in the present application, axial flow fans, cross-flow fans, centrifugal fans, and the like may be selected according to actual fan dimensions, the position of the air intake space, and the size of the space, which will not be elaborated herein.

The first lower air duct 2 is also assembled from the first lower housing 21 and the first upper housing 22, similar to the assembly of the second lower air duct 3, with the difference being that the first air chamber 20 and the second air chamber 24 are directly formed after the first lower housing 21 and the first upper housing 22 are assembled.

As an example of the present invention, a first wire groove 211 is provided on a side of the first lower housing 21 proximate to the base 103 for positioning connection wires of the second heat dissipation structure. This arrangement can constrain the connection wires, ensuring stable and reliable connections and facilitating maintenance.

For the first inverter 5, in addition to the inverter main body, a heat sink 72 is often provided, and the heat sink 72 is often located close to the inverter main body. In order to prevent the heat sink 72 from affecting the inverter main body, a first partition plate 26 is provided in the first air chamber 20. The first partition plate 26 is disposed between the inverter main body and the heat sink 72, so that heat dissipation from each of the two is as non-interfering as possible with the other. The first partition plate 26 is integrally formed with the first lower housing 21 or the first upper housing 22.

### Embodiment 2

To solve the problem in the prior art that the heat dissipation structure of dual-magnetron cooking appliances is unreasonably designed, resulting in poor heat dissipation effect, the applicant has made further improvements based on embodiment 1:

As shown in FIGS. 1-10, the cooking appliance includes a heat insulation cavity assembly 9, a rear air duct 1 is disposed at the rear of the heat insulation cavity assembly 9, the rear air duct 1 has a first flow channel 14 and a second flow channel 15, the air outlet of the inverter heat dissipation structure communicates with the first flow channel 14, the air outlet of the magnetron heat dissipation structure communicates with the second flow channel 15, and the air outlet direction of the first flow channel 14 and the air outlet direction of the second flow channel 15 are both parallel to the wall directly facing the rear side of the cooking appliance.

As an example of the present invention, the first flow channel 14 communicates with the first exhaust outlet 23, and the second flow channel 15 communicates with the second air outlet 63. Specifically, the first exhaust outlet 23 communicates with or connects to the first air inlet end 141 of the first flow channel 14, thereby achieving the combination between the heat dissipation structure of the second inverter 7 and the rear air duct 1, and the second air outlet 63 communicates with or connects to the second air inlet end of the second flow channel 15, thereby achieving the combination between the heat dissipation structure of the second magnetron 6 and the rear air duct 1.

The present application, by additionally providing the rear air duct 1, enables the heat dissipation airflow passing through the magnetron and the inverter to respectively enter the corresponding flow channels in the rear air duct 1, and then flow out of the rear air duct 1 along a direction parallel to the wall; thereby ensuring that the heat dissipation airflow exhausted from the cooking appliance at least does not all flow toward the wall, and can flow directly outward along the wall in a relatively smooth manner, without causing the heat dissipation airflow to accumulate in the narrow space between the rear side of the cooking appliance and the wall, avoiding situations such as airflow obstruction and heat accumulation, which helps the heat dissipation airflow to flow out smoothly and diffuse in a timely manner, so as to improve the heat dissipation effect.

The cooking appliance includes a rear housing 104, the rear housing 104 has a rear protrusion 1041, the side wall 1044 of the rear protrusion 1041 is provided with a first air outlet hole 1042 and a second air outlet hole 1043, the first air outlet hole 1042 is directly facing the air outlet of the first flow channel 14, and the second air outlet hole 1043 is directly facing the air outlet of the second flow channel 15. Thus, the rear housing 104 having the rear protrusion 1041 in conventional cooking appliances can be directly adopted, which on one hand can provide spatial clearance for certain components inside the cooking appliance, and on the other hand can utilize the side wall 1044 of the rear protrusion 1041 to directly machine the corresponding air outlet holes, without the need to additionally adjust the air outlet direction or air outlet structure on the rear housing 104, thereby achieving the air outlet direction of the heat dissipation airflow of the present application.

Preferably, the air outlet direction of the first flow channel 14 is at least one of upward, leftward, and rightward, and the air outlet direction of the second flow channel 15 is at least one of upward, leftward, and rightward. Since cooking appliances are often placed on a supporting surface, downward flow of heat dissipation airflow (such as toward the supporting tabletop) is avoided to prevent unnecessary airflow obstruction. Of course, if the cooking appliance is configured with a suspended rear end or is entirely suspended, the air outlet direction may be fully directed downward.

As a preferred embodiment of the present application, the air outlet of the first flow channel 14 faces upward and is designated as the upper air outlet 12, and the air outlet of the second flow channel 15 faces leftward or rightward and is designated as the side air outlet 13. Correspondingly, the rear housing 104 is provided with air outlet holes at corresponding positions on the side wall 1044.

The rear air duct 1 has a clearance protrusion 11 for providing clearance for the first waveguide housing 400 of the cooking appliance to avoid spatial interference between components. The clearance protrusion 11 is not independent of the flow channel structure and may have partial structural overlap with the first flow channel 14 and/or the second flow channel 15. The shape of the corresponding flow channel wall is appropriately adjusted to form spatial clearance for the first waveguide housing 400. Correspondingly, the cooking appliance includes a first motor 105. The first motor 105 cooperates with the first waveguide housing 400, a wave stirrer (not shown), and other structures, which may refer to the prior art. The present application does not elaborate on microwave transmission structures and wave stirring structures.

The first motor 105 is disposed in the first flow channel 14 or the second flow channel 15, and the rear air duct 1 is provided with a clearance portion 111 corresponding to the first motor 105. Thus, in the present application, during the process of discharging the magnetron heat dissipation airflow or inverter heat dissipation airflow to the outside, the heat dissipation airflow is also enabled to flow through the first motor 105 to dissipate heat from the first motor 105, which helps improve the heat dissipation effect of the entire cooking appliance. Preferably, the clearance portion 111 is a clearance opening structure, and the clearance portion 111 is disposed at a position close to the air outlet of the first flow channel 14 or close to the air outlet of the second flow channel 15 to ensure normal flow and discharge of the heat dissipation airflow.

In the present application, the two magnetrons are designated as the first magnetron 4 and the second magnetron 6 respectively, and the two inverters are designated as the first inverter 5 and the second inverter 7, respectively. The air outlets of the two magnetron heat dissipation structures may both communicate with the first flow channel 14, and the air outlets of the two inverter heat dissipation structures may both communicate with the second flow channel 15.

However, in consideration of structural configuration, spatial position allocation, and dimensions of the entire machine and components, the present application maintains the applicant's earlier heat dissipation flow channel (air duct) structure for the heat dissipation structures associated with the first magnetron 4 and the first inverter 5, and primarily coordinates the heat dissipation structures associated with the second magnetron 6 and the second inverter 7 with the rear air duct 1.

### Embodiment 3

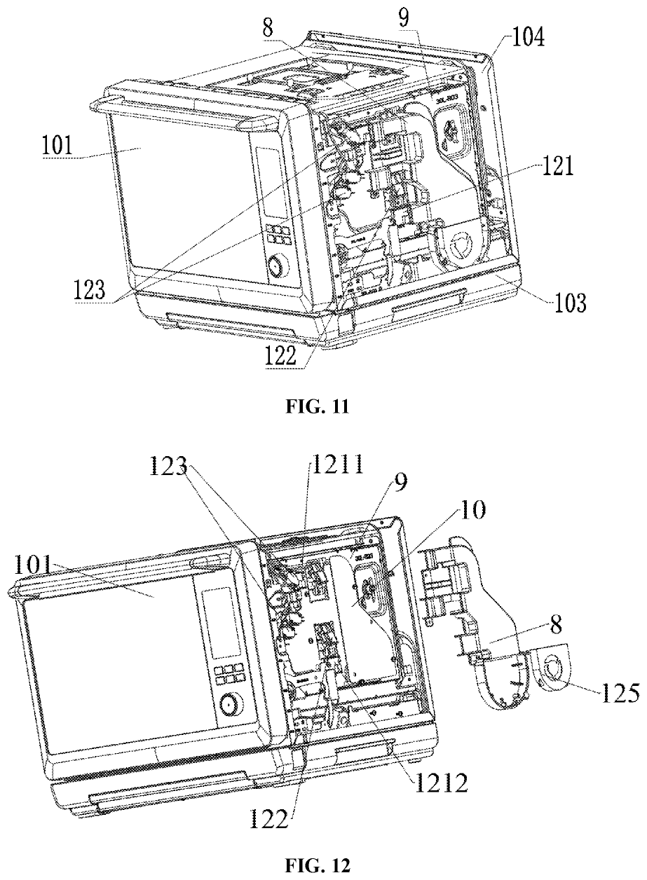

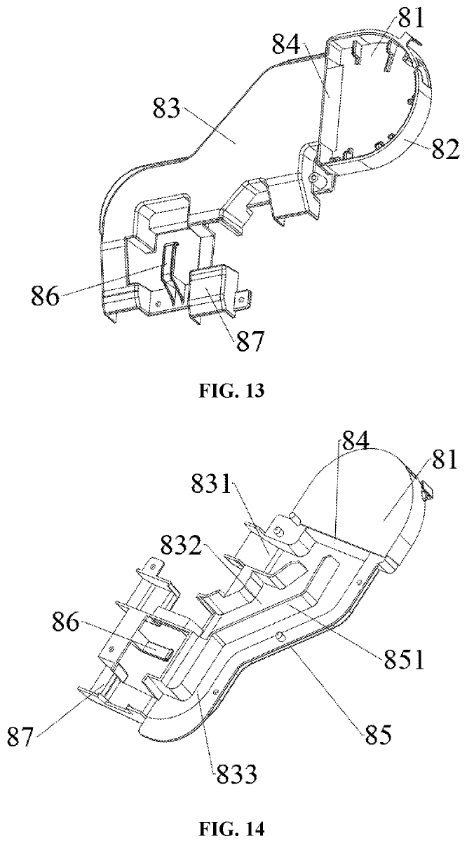

As shown in FIGS. 11-14, a cooking appliance includes a heat insulation cavity assembly 9, the heat insulation cavity assembly 9 includes a cooking cavity 91 and a heat insulation frame arranged sequentially from inside to outside, a heat insulation member is disposed between the cooking cavity 91 and the heat insulation frame, the heat insulation member is connected to the heat insulation frame, and the heat insulation frame is connected to the cooking cavity 91; a first magnetron 4 and a second magnetron 6 are disposed below the bottom of the heat insulation cavity assembly 9 for emitting microwaves into the cooking cavity 91; the cooking appliance further includes a lighting assembly 121 and a temperature sensing assembly 122 located at a side of the heat insulation cavity assembly 9, an air guide cover 8 is disposed at the side of the heat insulation cavity assembly 9, and a fifth fan 125 is disposed at one end of the air guide cover 8 for driving air flow to simultaneously dissipate heat from the lighting assembly 121 and the temperature sensing assembly 122.

This arrangement can utilize one fifth fan 125 to simultaneously dissipate heat from the lighting assembly 121, the temperature sensing assembly 122, and the microswitch 123 of the door assembly 101, satisfying the heat dissipation requirements at the side of the dual-magnetron cooking appliance; by providing the heat insulation frame and the heat insulation member, heat in the oven cavity can be effectively prevented from transferring to the outside, avoiding heat from the cooking cavity 91 being transferred to the side and thereby affecting the operational stability of the lighting assembly 121, the temperature sensing assembly 122, and the microswitch 123, while effectively concentrating heat in the cooking cavity 91, ensuring a good temperature rise rate in the oven cavity, helping to improve cooking efficiency, ensuring cooking results, and also reducing energy loss caused by heat transfer from the oven cavity to the outside.

As an example of the present invention, the lighting assembly 121 includes a first lamp body 1211 and a second lamp body 1212, the first lamp body 1211 is located above the second lamp body 1212; the temperature sensing assembly 122 includes a first sensor and a second sensor, the first sensor is located above the second sensor and on the downstream side of the first lamp body 1211.

As an example of the present invention, the air guide cover 8 includes a first bottom plate 81 disposed in close contact with the heat insulation cavity assembly 9, a first baffle plate 82 is disposed around the periphery of the first bottom plate 81, the first bottom plate 81 and the first baffle plate 82 enclose and form a mounting position for fixedly assembling the fifth fan 125; an air supply opening 84 is disposed on one side of the first baffle plate 82 for delivering air to the lighting assembly 121 and the temperature sensing assembly 122.

Preferably, the air guide cover 8 further includes a second bottom plate 83, the second bottom plate 83 is located at the upper edge of the first baffle plate 82 and extends toward a side away from the first baffle plate 82, the second bottom plate 83 is provided with a second baffle plate 85 and a blocking plate 851 on the side close to the heat insulation cavity assembly 9, the second baffle plate 85 is located at the outer edge of the second bottom plate 83 and cooperates with the blocking plate 851 to form a first air duct 831, a second air duct 832, and a third air duct 833, the first air duct 831 and the second air duct 832 are respectively used for heat dissipation of the second lamp body 1212 and the second sensor, and the third air duct 833 is used for heat dissipation of the first lamp body 1211 and the first sensor.

Preferably, the air guide cover 8 is provided with an air induction member 87 on a side remote from the first bottom plate 81, a microswitch 123 is provided on a side portion of the heat insulation cavity assembly 9, and the air induction member 87 is disposed directly facing the microswitch 123 for dissipating heat from the microswitch 123. This arrangement enables the fifth fan 125 to simultaneously dissipate heat from the lighting assembly 121, the temperature sensing assembly 122, and the microswitch 123, ensuring stable and reliable overall operation of the cooking appliance.

Preferably, there are two air induction members 87 arranged in a vertically spaced manner. This arrangement enables heat dissipation for multiple microswitches 123, while guiding airflow at the side of the cooking cavity 91 to prevent hot air from entering the electrical installation area located at the bottom of the cavity, thereby providing the cooking apparatus with a long service life and reliable operation.

Preferably, the cooking appliance further comprises a first mounting plate 10, the first mounting plate 10 is fixed on the heat insulation cavity assembly 9, the air guide cover 8 is disposed on a side of the first mounting plate 10 remote from the heat insulation cavity assembly 9, an air supply air duct is formed between the air guide cover 8 and the first mounting plate 10, and the first mounting plate 10 is made of a non-metallic material. This arrangement enables the first mounting plate 10 to provide a heat insulation effect, preventing heat from the heat insulation cavity assembly 9 from being conducted to the air guide cover 8, thereby maintaining a relatively low temperature at the side of the cooking cavity 91 and achieving good heat dissipation performance.

Preferably, the air guide cover 8 further comprises a snap-fit member 86, the snap-fit member 86 is located between the two air induction members 87 for restraining connecting wires. The air guide cover 8 is assembled with the first mounting plate 10 and/or the heat insulation cavity assembly 9 by means of screw connection and/or plug-in connection. This arrangement enables pre-positioning through plug-in connection, achieving both convenience and fastening reliability in assembly.

### Embodiment 4

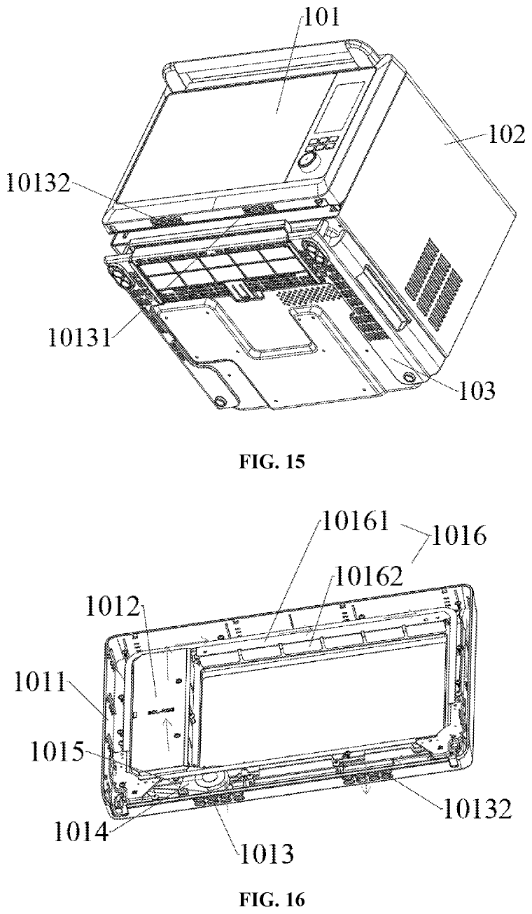

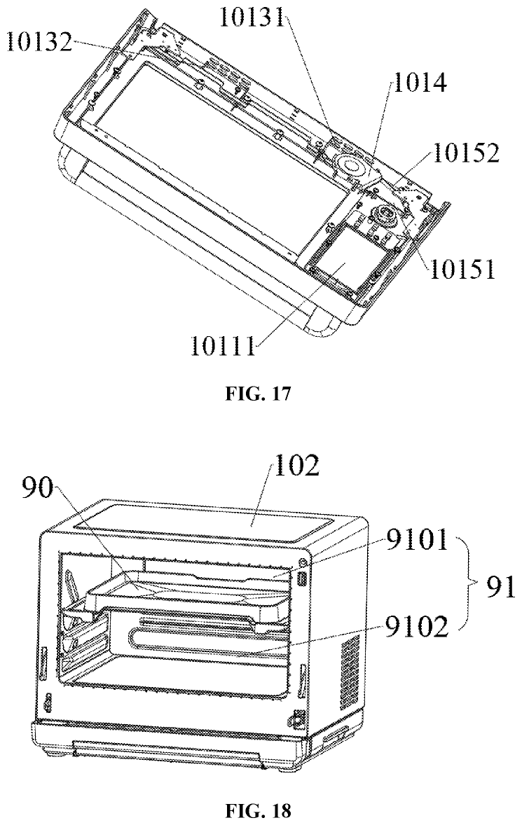

As shown in FIGS. 15-17, the cooking appliance includes a door assembly 101, the door assembly 101 comprising:

A door cover plate 1011, serving as the main structure of the door assembly 101, providing protection and support;

An electronic control box 1012, the electronic control box 1012 being installed on one side of the door cover plate 1011;

A heat dissipation air duct 1013, the electronic control box 1012 being disposed within the heat dissipation air duct 1013, the heat dissipation air duct 1013 providing an effective heat dissipation path for the electronic control box 1012 while assisting in the overall heat dissipation of the door assembly 101;

A fan assembly 1014, the fan assembly 1014 being used to drive airflow, the fan assembly 1014 being disposed within the heat dissipation air duct 1013 to enhance the heat dissipation effect.

This embodiment, by optimizing the design of the heat dissipation air duct 1013 and the fan assembly 1014, ensures efficient heat dissipation of the electronic control box 1012 while assisting in the overall heat dissipation of the door assembly 101, which can effectively solve the problem of poor heat dissipation in the door assembly 101 of cooking appliances and improve the operational stability and service life of the cooking appliance; integrating the fan assembly 1014 and the heat dissipation air duct 1013 within the door assembly 101 results in a compact structure, saves space, and improves the overall aesthetics and practicality of the cooking appliance.

As a preferred example of the present application, the heat dissipation air duct 1013 includes a first inlet 10131 and a first outlet 10132, the first inlet 10131 is located at the bottom of the door cover plate 1011, and the position of the first inlet 10131 is concealed, without affecting the aesthetic appearance of the cooking appliance.

As a preferred example of the present application, the first outlet 10132 is disposed at the bottom of the door cover plate 1011, and the position of the first outlet 10132 is concealed, without affecting the aesthetic appearance of the cooking appliance.

As a preferred example of the present application, the first inlet 10131 is disposed on a side close to the fan assembly 1014, shortening the path between the first inlet 10131 and the fan assembly 1014, so as to facilitate the fan assembly 1014 in drawing in cool air and improving heat dissipation efficiency.

The electronic control box 1012 includes an electronic control mounting housing and electronic control components disposed inside, an electronic control mounting area 10111 is provided on the door cover plate 1011, and the electronic control mounting housing and the electronic control components are installed in the electronic control mounting area 10111.

As a preferred example of the present application, the fan assembly 1014 is disposed below the electronic control box 1012, a first air guide structure 1015 is provided at an outlet of the fan assembly 1014, the first air guide structure 1015 is capable of guiding the cool air blown out by the fan assembly 1014 into the interior of the electronic control box 1012, ensuring that the cool air can directly blow toward the electronic control components inside the electronic control box 1012, thereby improving heat dissipation efficiency.

When the cooking appliance is in operation, the fan assembly 1014 is activated, drawing in cool air from the first inlet 10131 at the bottom of the door cover plate 1011, and through the guidance of the heat dissipation air duct 1013 and the first air guide structure 1015, the cool air flows through the electronic control box 1012 to cool the electronic control components; the heated air is discharged through the first outlet 10132 of the heat dissipation air duct 1013, forming a circulating heat dissipation system.

As a preferred example of the present application, the first air guide structure 1015 includes a second mounting plate 10151 and an air guide plate 10152, the air guide plate 10152 is vertically disposed above the second mounting plate 10151, the air guide plate 10152 is configured as an arcuate structure, allowing the airflow to gradually change direction when passing through, reducing airflow resistance and improving airflow efficiency; furthermore, the arcuate structure can also reduce noise to a certain extent, because a smooth airflow path helps reduce turbulence and vibration.

As a preferred example of the present application, the interior of the electronic control box 1012 forms an airflow channel, a second air guide structure 1016 is disposed on one side above the electronic control box 1012, an air outlet channel is formed between the second air guide structure 1016 and the door cover plate 1011, and the second air guide structure 1016 is capable of guiding air exiting from the interior of the electronic control box 1012 to flow along the air outlet channel to a side away from the electronic control box 1012, ensuring uniform heat dissipation and avoiding localized overheating.

As a preferred example of the present application, the second air guide structure 1016 includes a first air outlet baffle plate 10161 and a second air outlet baffle plate 10162, and the second air outlet baffle plate 10162 is vertically disposed below the first air outlet baffle plate 10161.

As a preferred example of the present application, the second air outlet baffle plate 10162 is provided in plurality, and the plurality of second air outlet baffle plates 10162 are disposed at intervals to optimize airflow distribution and improve heat dissipation effectiveness.

### Embodiment 5

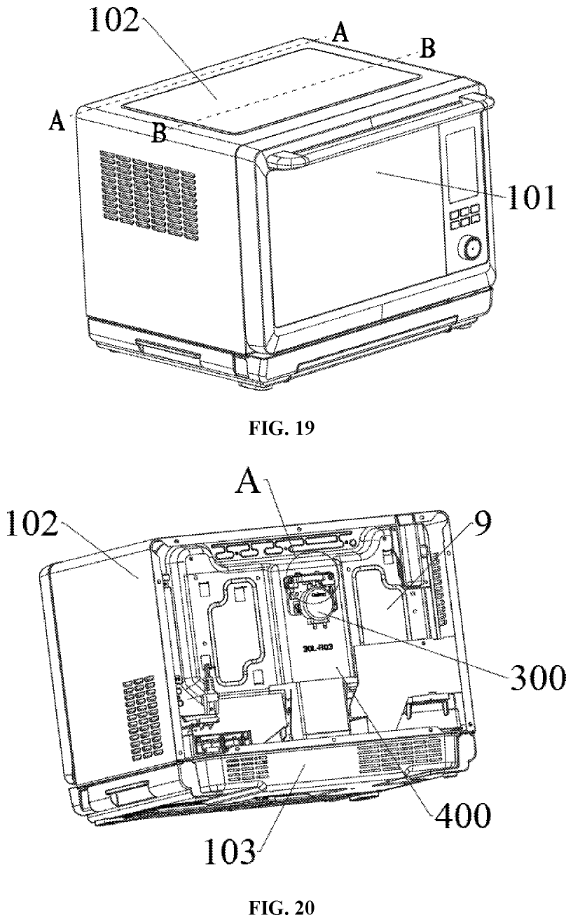

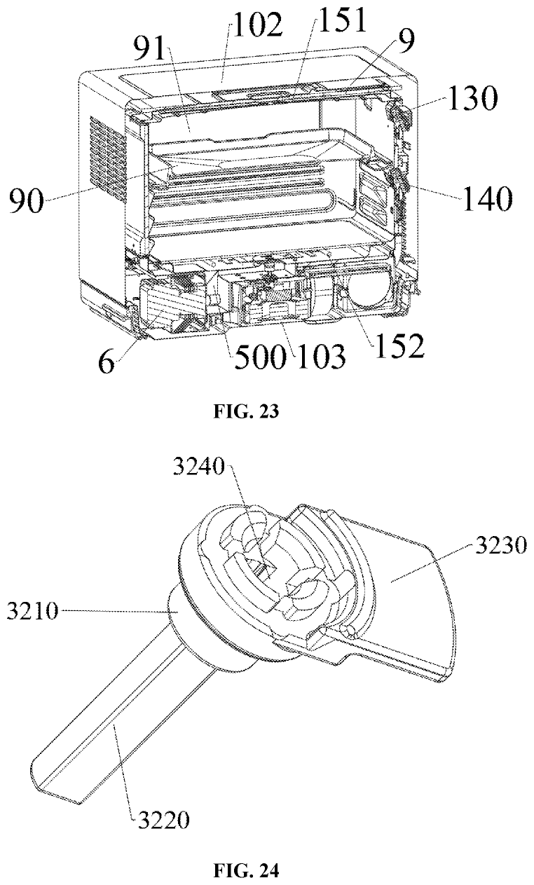

As shown in FIGS. 18-24, a cooking appliance includes a cooking cavity 91, a first magnetron 4, and a second magnetron 6. A horizontally placed partition member 90 may be selectively disposed within the cooking cavity 91. The partition member 90 is capable of shielding microwaves and dividing the cooking cavity 91 into a first space 9101 and a second space 9102 arranged in an upper-lower configuration. The first magnetron 4 and the second magnetron 6 selectively emit microwaves into the first space 9101 and the second space 9102, respectively. The cooking appliance further includes a temperature measurement assembly for detecting whether the partition member 90 is present within the cooking cavity 91.

This configuration divides the cooking cavity 91 into two relatively independent spaces through the partition member 90, thereby enriching the operating modes of the cooking appliance. When the partition member 90 is not present, the entire cooking cavity 91 can be heated; alternatively, when the partition member 90 is present, the first space 9101 and/or the second space 9102 can be selectively heated, thereby avoiding the situation of heating the entire cooking cavity 91 when there is a small amount of food, significantly reducing energy consumption, and being particularly suitable for regions with stringent requirements for low power consumption and high energy efficiency. Since the temperature rise rate of the partition member 90 differs from that of the cooking cavity 91, the temperature rise rate detected by the temperature measurement assembly can determine whether the partition member 90 is present, improving the intelligence level of the cooking appliance.

Preferably, the temperature measurement assembly includes a first temperature sensing member 130 and a second temperature sensing member 140. The first temperature sensing member 130 is located above the second temperature sensing member 140 and is used for detecting whether the partition member 90 is present within the cooking cavity 91 and whether food to be cooked is placed in the first space 9101. The second temperature sensing member 140 is used for detecting whether food to be cooked is placed in the second space 9102. As a preferred example of the present application, the temperature measurement assembly is temperature sensing assembly122.

This arrangement enables the first temperature sensing member 130 and the second temperature sensing member 140 to respectively detect the temperature of food in the first space 9101 and the second space 9102 when the partition member 90 is present, thereby allowing the first space 9101 and the second space 9102 to operate relatively independently. For example, the first space 9101 can be used for defrosting while the second space 9102 simultaneously performs heating, with the two not interfering with each other, thereby improving the space utilization of the appliance.

Preferably, the cooking appliance further includes a first waveguide housing 400 for inputting microwaves generated by the first magnetron 4 into the cooking cavity 91. The first waveguide housing 400 is provided with a microwave stirring device 300. The microwave stirring device 300 includes a second motor 310, a connecting rod 320, and a stirrer 330 that are drivingly connected. The microwave stirring device 300 further includes a sensing member 350 electrically connected to a control module. The sensing member 350 is located at a side of the connecting rod 320 and is not in contact with the connecting rod 320. The extension plate 3230 rotates synchronously with the connecting rod 320 and generates a signal when passing the sensing member 350.

This arrangement enables real-time monitoring of whether the microwave stirring device 300 is operating normally, avoiding safety hazards caused by abnormal operation of the microwave stirring device 300. Furthermore, there is no physical contact between the sensing member 350 and the extension plate 3230, avoiding contact oxidation or elastic failure caused by friction in traditional microswitches 123, with the service life extended to more than 100,000 cycles. Preferably, the side of the connecting rod 320 is provided with the extension plate 3230, and the extension plate 3230 is arranged perpendicular to the output shaft of the second motor 310. This arrangement, by installing the sensing member 350 at the side of the connecting rod 320, does not occupy the axial space of the connecting rod 320, resulting in a more compact structure.

As an example of the present invention, the sensing member 350 is a magnetic sensor, and the connecting rod 320 is made of a non-metallic heat-insulating material. This arrangement enables the heat-insulating function of the connecting rod 320 to prevent the second motor 310 from being easily affected by high temperatures during operation, thereby reducing heat loss and overheating risks, improving the operating efficiency and service life of the second motor 310, ensuring smooth rotation of the stirrer 330, and thus enabling more uniform distribution of microwaves within the cooking appliance cavity.

Preferably, the microwave stirring device 300 includes a second bracket 360 for fixing the second motor 310 and the sensing member 350. A portion of the second bracket 360 protrudes toward a side close to the second motor 310 to form a second protrusion 3610. The second protrusion 3610 is provided with a first mounting hole. A portion of the first waveguide housing 400 protrudes toward a side away from the second motor 310 to form a third protrusion 410. The third protrusion 410 is provided with a second mounting hole. The second mounting hole and the first mounting hole are arranged opposite to each other. An outer edge of the second mounting hole is provided with an annular rib 4110. The annular rib 4110 extends toward a side close to the second motor 310. The connecting rod 320 passes sequentially through the first mounting hole and the second mounting hole and is then connected to the stirrer 330.

This arrangement forms a cavity between the second protrusion 3610 and the third protrusion 410, which can effectively prevent microwaves leaking from the first mounting hole from conducting outward. The annular rib 4110 and the connecting rod 320 form a closed conductive loop that confines the microwaves within the first waveguide housing 400, effectively preventing leakage from the cooking appliance to reduce impact on the sensing member 350 and ensuring stable and reliable operation thereof. Meanwhile, the second bracket 360 and the first waveguide housing 400 form a double-layer structure with good heat insulation effect. Preferably, the second bracket 360 is a non-metallic member. This arrangement can effectively prevent heat in the cooking cavity 91 from conducting to the microwave stirring device 300, ensuring stable and reliable operation of the sensing member 350.

Preferably, the cooking appliance further includes a second waveguide housing 500 for inputting microwaves generated by the second magnetron 6 from the bottom of the cooking cavity 91, the first waveguide housing 400 is used for inputting microwaves generated by the first magnetron 4 from the rear side of the cooking cavity 91, and the microwave stirring device 300 is disposed on the second waveguide housing 500. This arrangement can significantly improve the operational safety and reliability of the cooking appliance.

Preferably, the cooking appliance further includes a heating assembly 150 electrically connected to the control module, the heating assembly 150 includes a first heating element 151 and a second heating element 152, the first heating element 151 is disposed between the cooking cavity 91 and the heat insulation member, and the second heating element 152 is located within the cooking cavity 91 and proximate to the bottom position.

Preferably, the first heating element 151 includes a first insulating sheet, a heating wire, and a second insulating sheet arranged sequentially from top to bottom, the heating wire is electrically connected to the control module, the first heating element 151 is located above the top of the cooking cavity 91 and is in close contact with the top plate of the cooking cavity 91, the first insulating sheet and the second insulating sheet are mica sheets, the second heating element 152 is a heating tube, and the second heating element 152 is located within the cooking cavity 91 and proximate to the bottom position.

This arrangement enables heating of the cooking cavity 91 from both upper and lower sides, allowing the cooking appliance to provide higher cooking temperatures and achieve ultra-high temperature cooking functions; meanwhile, when the partition member 90 is present, the first heating element 151 and the second heating element 152 can respectively heat the first space 9101 and the second space 9102, with each portion capable of achieving both microwave heating and grilling functions, making cooking modes more diversified; furthermore, the first heating element 151 is in close contact with the top plate, enabling heat to be conducted uniformly through the side walls of the cooking cavity 91, improving the uniformity of temperature distribution within the oven cavity, and avoiding localized burning.

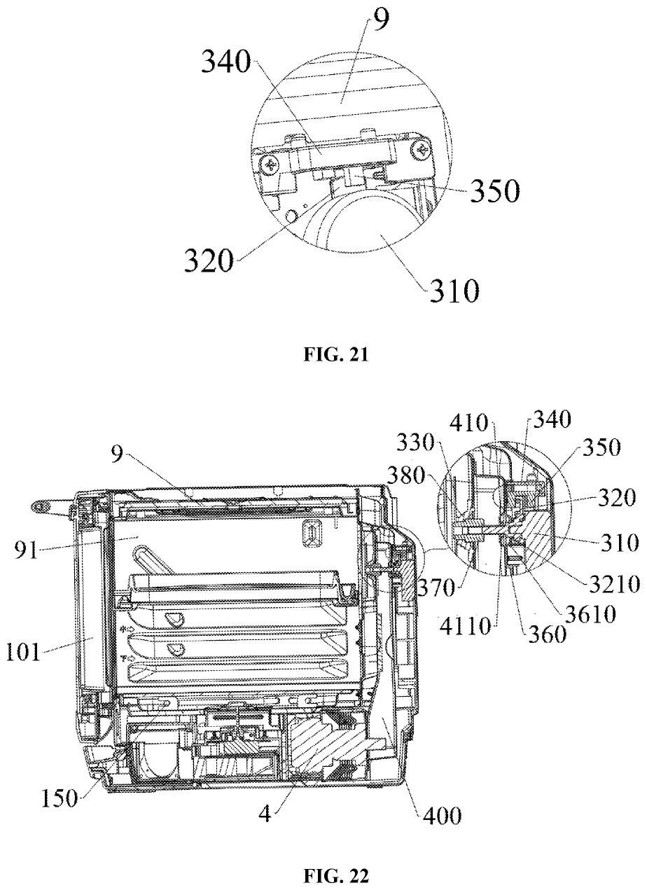

As shown in FIGS. 21, 22, and 24, the connecting rod 320 is made of non-metallic heat-insulating material. This arrangement enables the heat insulation function of the connecting rod 320 to prevent the second motor 310 from being easily affected by high temperatures during operation, thereby reducing heat loss and overheating risks, improving the operating efficiency and service life of the second motor 310, ensuring smooth rotation of the stirrer 330, and thus making the microwave distribution within the cooking appliance cavity more uniform.

As an example of the present utility model, the microwave stirring device 300 includes a second bracket 360 fixed to the waveguide assembly for fixing the second motor 310. A first bracket 340 is disposed on one side of the second bracket 360, and the sensing member 350 is fixedly disposed on the first bracket 340, wherein the sensing member 350 is a Hall element or an infrared photoelectric sensor. This arrangement enables independent installation of the second bracket 360 and the first bracket 340, preventing vibration from the second motor 310 from being directly transmitted to the sensing member 350, thereby improving the stability of detection signals; by providing the second bracket 360, the sensing member 350 can be shielded from the cooking cavity 91, further improving operational stability and reliability. Preferably, the first bracket 340 is made of galvanized steel plate or aluminum alloy, forming a Faraday cage effect, reducing the interference of magnetron radiation on the Hall element by 90%.

Preferably, a portion of the second bracket 360 protrudes toward a side close to the second motor 310 to form a second protrusion 3610, and the second protrusion 3610 is provided with a first mounting hole. The waveguide assembly includes a first waveguide housing 400, and a portion of the first waveguide housing 400 protrudes toward a side away from the second motor 310 to form a third protrusion 410. The third protrusion 410 is provided with a second mounting hole, and the second mounting hole is disposed opposite to the first mounting hole. An annular rib 4110 is provided on the outer edge of the second mounting hole, and the annular rib 4110 extends toward the side close to the second motor 310. The connecting rod 320 sequentially passes through the first mounting hole and the second mounting hole, and is then connected to the stirrer 330.

This arrangement forms a cavity between the second protrusion 3610 and the third protrusion 410, which can effectively prevent microwaves leaking from the first mounting hole from being conducted outward. The annular rib 4110 and the connecting rod 320 form a closed conductive loop, limiting microwave leakage within the first waveguide housing 400, further reducing microwave leakage to below 0.3mW/cm², effectively reducing the impact of leakage from the cooking appliance on the normal operation of the sensing member 350.

As an example of the present invention, a coupler 370 is disposed at an end of the connecting rod 320 away from the second motor 310. The coupler 370 is fixedly engaged with the stirrer 330 through plug-in fitting. A connecting shaft sleeve 380 is disposed on the outer side of the coupler 370. The coupler 370 is capable of rotating relative to the connecting shaft sleeve 380 under the driving action of the connecting rod 320. The connecting shaft sleeve 380 is fixed to the cooking cavity 91 and is capable of supporting the stirrer 330.

This arrangement employs plug-in fitting between the coupler 370 and the stirrer 330, ensuring a secure connection between the two and preventing the stirrer 330 from loosening or falling off during operation. Meanwhile, the connecting shaft sleeve 380 is fixed to the bottom wall or side wall of the cooking cavity 91, providing stable support for the stirrer 330 and enhancing its operational stability, enabling the stirrer 330 to rotate flexibly under the driving of the connecting rod 320. This facilitates uniform distribution of microwaves within the cooking appliance cavity, improving heating performance.

As an example of the present invention, the connecting rod 320 includes a first connecting portion 3210, with a first plug-in hole 3240 disposed at one portion thereof for connecting to the rotating shaft of the second motor 310; and further includes a second connecting portion 3220, which is capable of extending into the coupler 370 and driving it to rotate integrally therewith. This arrangement enables integrated rotation of the connecting rod 320 and the stirrer 330, ensuring effective transmission of power, thereby simplifying the assembly process and improving the stability and rotational efficiency of the overall structure.

As an example of the present invention, the connecting shaft sleeve 380 includes a shaft sleeve plate, a third positioning flange is provided on the shaft sleeve plate, the third positioning flange is used to accommodate the positioning coupler 370 and support the stirrer 330. A first connecting plate and a first plug-in block are respectively provided on opposite sides of the shaft sleeve plate, the first plug-in block is plug-in positioned with the cooking cavity 91, and the first connecting plate is fixed to the cooking cavity 91 by screws.

This arrangement, through the ingeniously designed third positioning flange, ensures firm positioning of the coupler 370 and supports the stirrer 330, enhancing the stability of the overall structure; meanwhile, the screw fixing and plug-in positioning design between the connecting shaft sleeve 380 and the cooking cavity 91 simplifies the installation process, achieving rapid and accurate assembly; furthermore, the provision of the fool-proof plate and the first plug-in block effectively prevents installation errors, further ensuring stable installation of the connecting shaft sleeve 380, thereby achieving efficient and firm connection among the stirrer 330, the coupler 370, and the connecting shaft sleeve 380.

Preferably, a fifth connecting hole is provided on the first connecting plate, the first connecting plate is fixed to the cooking cavity 91 by screws through a connecting screw passing through the fifth connecting hole, a fool-proof plate is provided on the side of the shaft sleeve plate away from the first connecting plate, and the first plug-in block is provided on the lower surface of the first connecting plate and extends beyond the fool-proof plate, thereby achieving rapid plug-in positioning when installing the connecting shaft sleeve 380 with the cooking cavity 91.

The cooking appliance further includes conventional components such as an outer casing 102, electrical control components, and other structures. Since these conventional components may all adopt existing technologies, they will not be described in detail herein.

Although the present invention is disclosed as above, the present invention is not limited thereto. Any person skilled in the art may make various changes and modifications without departing from the spirit and scope of the present invention. Therefore, the protection scope of the present invention shall be subject to the scope defined by the claims.

1. A cooking appliance, wherein the cooking appliance comprises a heat insulation cavity assembly, the heat insulation cavity assembly comprising a cooking cavity and a heat insulation frame arranged sequentially from inside to outside, a heat insulation member being disposed between the cooking cavity and the heat insulation frame, the heat insulation member being connected with the heat insulation frame and the cooking cavity; a heat dissipation structure being disposed outside the heat insulation cavity assembly.

2. The cooking appliance according to claim 1, wherein the cooking appliance comprises a base, the base being located below the heat insulation cavity assembly, an air inlet structure being disposed on a front side of the base, a first magnetron, a second magnetron, and an electronic control structure being disposed between the heat insulation cavity assembly and the base; a first heat dissipation structure being disposed at a side of the first magnetron, a second heat dissipation structure being disposed at a side of the second magnetron, the electronic control structure being located between an inlet end of the first heat dissipation structure and/or the second heat dissipation structure and the air inlet structure.

3. The cooking appliance according to claim 2, wherein the first heat dissipation structure and the second heat dissipation structure are provided with a sponge member on a side close to the base, the sponge member cooperating with the first heat dissipation structure and the second heat dissipation structure to form an air inlet space, the electronic control structure being located within the air inlet space.

4. The cooking appliance according to claim 3, wherein the first heat dissipation structure comprises a first fan and a first air guide member, the first fan being disposed on an air inlet side of the first magnetron, the first air guide member being disposed on an air outlet side of the first magnetron, an end of the first air guide member remote from the first magnetron being provided with a first air outlet.

5. The cooking appliance according to claim 4, wherein the first heat dissipation structure comprises a second lower air duct, a first inverter being disposed in the second lower air duct, the first inverter being electrically connected to the first magnetron, a second fan being disposed on an air inlet side of the second lower air duct, a second exhaust outlet being disposed on an air outlet side of the second lower air duct, the second exhaust outlet being in communication with a heat dissipation air outlet hole.

6. The cooking appliance according to claim 5, wherein the second lower air duct comprises a second lower housing, the second lower housing being provided with a second wire groove, a second partition plate being disposed between the second lower housing and the first air guide member, the second partition plate comprising a connecting plate and a second folded edge connected to each other, the second folded edge extending toward a side of the second lower housing and at least partially covering the second wire groove.

7. The cooking appliance according to claim 3, wherein the second heat dissipation structure comprises a third fan and a second air guide member, an air outlet side of the third fan is in communication with an air inlet side of the second magnetron, the second air guide member is disposed at an air outlet side of the second magnetron, and a second air outlet is disposed at an end of the second air guide member remote from the second magnetron.

8. The cooking appliance according to claim 7, wherein the second heat dissipation structure further comprises a mounting bracket and a blocking member, the mounting bracket is configured to fix the second fan, the blocking member is located at a side of the mounting bracket proximate to the second magnetron, the blocking member comprises a third partition plate disposed vertically, and a gap exists between the third partition plate and the mounting bracket.

9. The cooking appliance according to claim 8, wherein the second heat dissipation structure further comprises a first lower air duct and a fourth fan, a second inverter is disposed inside the first lower air duct, the second inverter is electrically connected to the second magnetron, the fourth fan is disposed at an inlet side of the first lower air duct, and a first exhaust outlet is disposed at an air outlet side of the first lower air duct.

10. The cooking appliance according to claim 1, wherein a rear air duct is disposed at a rear of the heat insulation cavity assembly, the rear air duct has a first flow channel and a second flow channel, the first flow channel is in communication with a first exhaust outlet, the second flow channel is in communication with a second air outlet, and an air outlet direction of the first flow channel and an air outlet direction of the second flow channel are both parallel to a wall directly facing a rear side of the cooking appliance.

11. The cooking appliance according to claim 10, wherein the cooking appliance comprises a rear housing, the rear housing has a rear protrusion, a side wall of the rear protrusion is provided with a first air outlet hole and a second air outlet hole, the first air outlet hole is disposed corresponding to an air outlet of the first flow channel, and the second air outlet hole is disposed corresponding to an air outlet of the second flow channel.

12. The cooking appliance according to claim 1, wherein the cooking appliance further comprises a lighting assembly and a temperature sensing assembly located at a side of the heat insulation cavity assembly, an air guide cover is disposed at a side of the heat insulation cavity assembly, and a fifth fan is disposed at one end of the air guide cover, configured to drive air flow to simultaneously dissipate heat from the lighting assembly and the temperature sensing assembly.

13. The cooking appliance according to claim 12, wherein the air guide cover comprises a first bottom plate arranged in close contact with the heat insulation cavity assembly, a first baffle plate is provided at the periphery of the first bottom plate, the first bottom plate and the first baffle plate enclose to form a mounting position for fixedly assembling the fifth fan; an air supply opening is provided on one side of the first baffle plate for delivering air to the lighting assembly and the temperature sensing assembly.

14. The cooking appliance according to claim 13, wherein the air guide cover is provided with an air induction member on a side away from the first bottom plate, a microswitch is provided at a side portion of the heat insulation cavity assembly, and the air induction member is arranged directly facing the microswitch for dissipating heat from the microswitch.

15. The cooking appliance according to claim 13, wherein the cooking appliance further comprises a mounting plate, the mounting plate is fixed on the heat insulation frame, the air guide cover is provided on a side of the mounting plate away from the heat insulation frame, an air supply air duct is formed between the air guide cover and the mounting plate, and the mounting plate is made of non-metallic material.

16. The cooking appliance according to claim 1, wherein the cooking appliance comprises a door assembly, the door assembly comprising:
a door cover plate; and
a heat dissipation air duct formed in the door cover plate, wherein an electronic control box and a fan assembly are provided in the heat dissipation air duct.

17. The cooking appliance according to claim 16, wherein the heat dissipation air duct comprises a first inlet and a first outlet, and both the first inlet and the first outlet are located at the bottom of the door cover plate.

18. The cooking appliance according to claim 16, wherein the fan assembly is disposed below the electronic control box, a first air guide structure is provided at an outlet of the fan assembly, and the first air guide structure is capable of guiding cool air blown out by the fan assembly into the interior of the electronic control box.

19. The cooking appliance according to claim 18, wherein the first air guide structure comprises a mounting plate and an air guide plate, the air guide plate is vertically disposed above the mounting plate, and the air guide plate is configured as an arcuate structure.

20. The cooking appliance according to claim 18, wherein an airflow channel is formed inside the electronic control box, a second air guide structure is provided on one side above the electronic control box, an air outlet channel is formed between the second air guide structure and the door cover plate, and the second air guide structure is capable of directing air exiting from the interior of the electronic control box to flow along the air outlet channel to a side away from the electronic control box.
